(19) United States
(12) Patent Application Publication
(10) Pub. No.: US 2004/0189558 A1
(43) Pub. Date: Sep. 30, 2004

(54) Drive method and drive device for light emitting display panel

(75) Inventors: Takayoshi Yoshida, Yonezawa-shi (JP); Katsuhiro Kanauchi, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Tendo-shi (JP)

(21) Appl. No.: 10/788,465

(22) Filed: Mar. 1, 2004

(30) Foreign Application Priority Data
Mar. 31, 2003 (JP) 2003-093812

(51) Int. Cl. G09G 3/32

(52) U.S. Cl. 345/82

(57) ABSTRACT

In the case where time gradation is implemented, there is provided a drive method for a passive drive type light emitting display panel by which an excellent gradation expression can be realized without subdividing intensity resolution so much. Provided is an intensity increase period in which the light emission intensity of a light emitting element is gradually increased allowing the light emission intensity to reach a constant intensity state within a predetermined period from a scan start in one scan period or an intensity decrease period in which the light emission intensity of the light emitting element is gradually decreased from the constant intensity state within a predetermined period which is immediately before the completion of the scan period. Since the intensity can be found by time integral calculus for the light emission response, in the case where the intensity increase period and/or the intensity decrease period is provided, a minimum time resolution in one scan period can be set largely, and it becomes unnecessary to increase the clock speed.

### BACKGROUND OF THE INVENTION

1. Field of the Invention

The present invention relates to a light emitting display panel in which for example an organic EL (electroluminescent) element is employed as a light emitting element, and particularly to a drive method and a drive device of a passive drive type light emitting display panel in which an excellent gradation expression can be realized without subdividing intensity resolution so much in the case where time gradation is implemented.

2. Description of the Related Art

A display panel which is constructed by arranging light emitting elements in a matrix pattern has been developed widely, and as the light emitting element employed in such a display panel, an organic EL element in which an organic material is employed in a light emitting layer has attracted attention. This is because of backgrounds one of which is that by employing, in the light emitting layer of the element, an organic compound which enables an excellent light emitting characteristic to be expected, a high efficiency and a long life have been achieved which make an EL element satisfactorily practicable.

The organic EL element can be electrically represented by an equivalent circuit as shown in FIG. 1. That is, the organic EL element can be replaced by a structure composed of a diode element E and a parasitic capacitance element Cp which is coupled in parallel to this diode element, and the organic EL element has been considered as a capacitor like light emitting element. When a light emission driving voltage is applied to this organic EL element, at first, electrical charges corresponding to the electric capacity of this element flow into an electrode as a displacement current and are accumulated. Then, it can be considered that when the voltage exceeds a determined voltage (light emission threshold voltage=Vth) peculiar to the element in question, current begins to flow from the electrode (anode side of the diode element E) to an organic layer constituting the light emitting layer so that the element emits light at an intensity proportional to this current.

FIG. 2 shows light emission static characteristics of such organic EL element. According to these, the organic EL element emits light at an intensity (L) approximately proportional to drive current (I) as shown in FIG. 2A and emits light while current (I) flows drastically when the drive voltage (V) is the light emission threshold voltage (Vth) or higher as shown in FIG. 2B. In other words, when the drive voltage is the light emission threshold voltage (Vth) or lower, current rarely flows in the EL element, and the EL element does not emit light. Therefore, the EL element has an intensity characteristic that in a light emission possible region in which the voltage is higher than the threshold voltage (Vth), the greater the value of the voltage (V) applied to the EL element becomes, the higher the light emission intensity (L) of the EL element becomes as shown by the solid line in FIG. 2C.

It has been known that the intensity property of the organic EL element changes due to temperature changes approximately as shown by broken lines in FIG. 2C. That is, while the EL element has a characteristic that the greater the value of the voltage (V) applied thereto, the higher the light emission intensity (L) thereof in the light emission possible region in which the voltage is higher than the light emission threshold voltage as described above, the EL element also has a characteristic that the higher the temperature becomes, the lower the light emission threshold voltage becomes. Accordingly, the EL element becomes in a state where light emission of the EL element is possible by a lower applied voltage as the temperature becomes higher, and thus the EL element has a temperature dependency of the intensity that the EL element is brighter at a high temperature and is darker at a lower temperature though the same light emission possible voltage is applied.

In general, a constant current drive is performed for the organic EL element due to the reason that the voltage vs. intensity characteristic is unstable with respect to temperature changes as described above while the current vs. intensity characteristic is stable with respect to temperature changes, the reason that the organic EL element is drastically deteriorated by an excess current, and the like. As a display panel employing such organic EL elements, a passive drive type display panel in which the elements are arranged in a matrix pattern has been put into practical use already.

As described above, since the organic EL element is a capacitor like load, while the constant current drive is merely performed, a rising of the voltage between both ends of the element, that is, a rising of light emission, is not fast. Particularly, in the display panel by the passive drive method, since an light emission operation of the EL element is performed in an instant only at the time of scan, making the ratio of light emittable time during a scan period as great as possible by making the rising of light emission as steep as possible has been considered.

As means for making the rising of light emission of the EL element as steep as possible, some methods have been known such as a cathode reset method (e.g., refer to Patent document 1) in which the parasitic capacitance element is charged from the cathode side of the element by rush current, a constant current charge method (e.g., refer to Patent document 2) in which the parasitic capacitance element is charged from the anode side of the element by a large amount of current, a constant voltage charge method (e.g., refer to Patent document 2) in which the parasitic capacitance element of the element is charged from a constant voltage source, and the like.

[Patent document 1]

Japanese Patent Application Laid-Open No. H9-232074 (paragraphs 0018 to 0034 and FIGS. 1 to 4)

[Patent document 2]

Japanese Patent Application Laid-Open No. 2001-331149 (paragraphs 0015 to 0026 and FIGS. 1 to 3)

[Patent document 3]

Japanese Patent Application Laid-Open No. H11-231834 (paragraphs 0027 to 0032 and FIGS. 1 to 3)

Meanwhile, in the case where a charging means for the capacitance element as described above is adopted, the time required for emitting light in an EL element is shortened, and generally a light emission response characteristic has a rectangular or spike-like rising as shown in FIGS. 3A, 3B. That is, the horizontal axes in FIG. 3 represent the lighting period (lighting progress time t) of the element in the scan period of one line, and the vertical axes represent the light emission intensity (L). For example, in the case where the above-mentioned cathode reset method is adopted, the charging operation for the parasitic capacitance of an EL element which will be a next scan lighting object is implemented by rush current via respective parasitic capacitances in the parallel state of the other EL elements which will not be the scan lighting object. In this case, in general, since this charging operation is implemented utilizing a reverse bias voltage VM which is higher than a forward voltage Vf of an EL element in a lighting state, the rising of the lighting is the spike-like rising as shown in FIG. 3B. In the case where the gradation expression is implemented in a display panel of this type, time gradation which controls a light emission time can be utilized suitably. In this time gradation expression, when a PWM (pulse width modulation) gradation method is utilized, the gradation (PWM time) vs. intensity characteristic becomes the time integral of the light emission response waveform shown in FIG. 3. Accordingly, in the case of control in which PWM is equally divided by the rectangular light emission drive as shown in FIG. 3A, a characteristic in which gradation is linear is obtained.

However, an ideal gradation vs. intensity characteristic is supposed to be a gamma curve in which gamma (visual degree)=approximately 1.8 to 2.2 as shown in FIG. 4. Accordingly, it is necessary to make the intensity difference between gradations small in a low gradation side and to make it large in a high gradation side. The minimum intensity resolution in the gamma curve corresponds to the intensity difference between the 0th gradation and the first gradation. Accordingly, in the case where one tries to obtain a gamma characteristic by the rectangular light emission drive as shown in FIG. 3A, it is necessary to make a PWM resolution of a low gradation side small. Table 1 shows results of calculation of how large minimum PWM resolution is necessary taking a 16 step gradation display of the rectangular light emission drive as an example.

TABLE 1

| | linear | γ = 1.8 | γ = 2.0 | γ = 2.2 |
|---|---|---|---|---|
| Time resolution (when PWM | 0.067 | 0.008 | 0.004 | 0.003 |
| 100% is treated as 1) | | | | |
| Minimum resolution | 1.000 | 8.727 | 15.000 | 25.782 |
| magnification (for gamma = 1) | | | | |

According to Table 1, for example, when gamma=2.0 is to be obtained, it is shown that 15 times of resolution is necessary for linear gradation. This corresponds to the case of the rectangular light emission drive as shown in FIG. 3A. Particularly when the rising of the light emission is spike-like as shown in FIG. 3B, it is obvious that a resolution smaller than that of the rectangular light emission drive is necessary.

In sum, in a drive in which the light emission response is rectangular or spike-like as shown in FIG. 3, in order to obtain a gamma characteristic, it is necessary to make the resolution small. In other words, a faster clock signal is necessary in order to make the resolution small. At the same time, the EL element has a temperature dependency as described based on FIG. 2C, and therefore changes in the light emission rising depending on temperature largely influences the gamma characteristic.

### SUMMARY OF THE INVENTION

The present invention has been developed as attention to the above-described problems has been paid, and it is an object of the present invention to provide a drive method and a drive device for a passive drive type light emitting display panel by which an excellent gradation expression can be realized without subdividing intensity resolution so much in the case where the above-mentioned time gradation is performed.

A drive method of a light emitting display panel according to the present invention which has been developed in order to carry out the object described above is, as described in a first aspect, a drive method of a light emitting display panel in which light emitting elements are connected at respective crossing points between a plurality of data lines and a plurality of scan lines so that the light emitting elements connected to the respective scan lines are sequentially selectively lighted by sequentially scanning the scan lines, characterized in that provided is at least one of an intensity increase period in which a light emission intensity of the light emitting element is gradually increased allowing the light emission intensity to reach a constant intensity state within a predetermined period from a scan start in one scan period or an intensity decrease period in which the light emission intensity of the light emitting element is gradually decreased from the constant intensity state within a predetermined period which is immediately before the completion of the scan period.

A drive device of a light emitting display panel according to the present invention which has been developed in order to carry out the object described above is, as described in a tenth aspect, a drive device of a light emitting display panel of a passive drive system in which light emitting elements are connected at respective crossing points between a plurality of data lines and a plurality of scan lines so that the light emitting elements connected to the respective scan lines are sequentially selectively lighted by sequentially scanning the scan lines, characterized in that provided is at least one of an intensity increase period in which a light emission intensity of the light emitting element is gradually increased allowing the light emission intensity to reach a constant intensity state within a predetermined period from a scan start in one scan period or an intensity decrease period in which the light emission intensity of the light emitting element is gradually decreased from the constant intensity state within a predetermined period which is immediately before the completion of the scan period.

### BRIEF DESCRIPTION OF THE DRAWINGS

FIG. 1 is an equivalent circuit diagram showing the electrical structure of an organic EL element.

FIGS. 2A, 2B and 2C are characteristic graphs explaining electrical static characteristics of the organic EL element.

FIGS. 3A and 3B are characteristic graphs explaining light emission response characteristics adopted in a conventional drive method.

FIG. 4 is a characteristic graph explaining the relationship between the gradation and the light emission intensity.

FIG. 5 is a characteristic graph showing an example of light emission responses in a scan period.

FIG. 6 is a characteristic graph showing an example of increases of intensities corresponding to the light emission responses shown in FIG. 5.

FIG. 7 is a characteristic graph for explaining drive methods according to the present invention.

FIG. 8 is a connection diagram showing a first embodiment in which a drive method according to the present invention is utilized.

FIGS. 9A and 9B are timing diagrams explaining operations in the structure shown in FIG. 8.

FIG. 10 is a connection diagram showing a second embodiment in which a drive method according to the present invention is utilized.

FIG. 11 is timing diagrams explaining operations in the structure shown in FIG. 10.

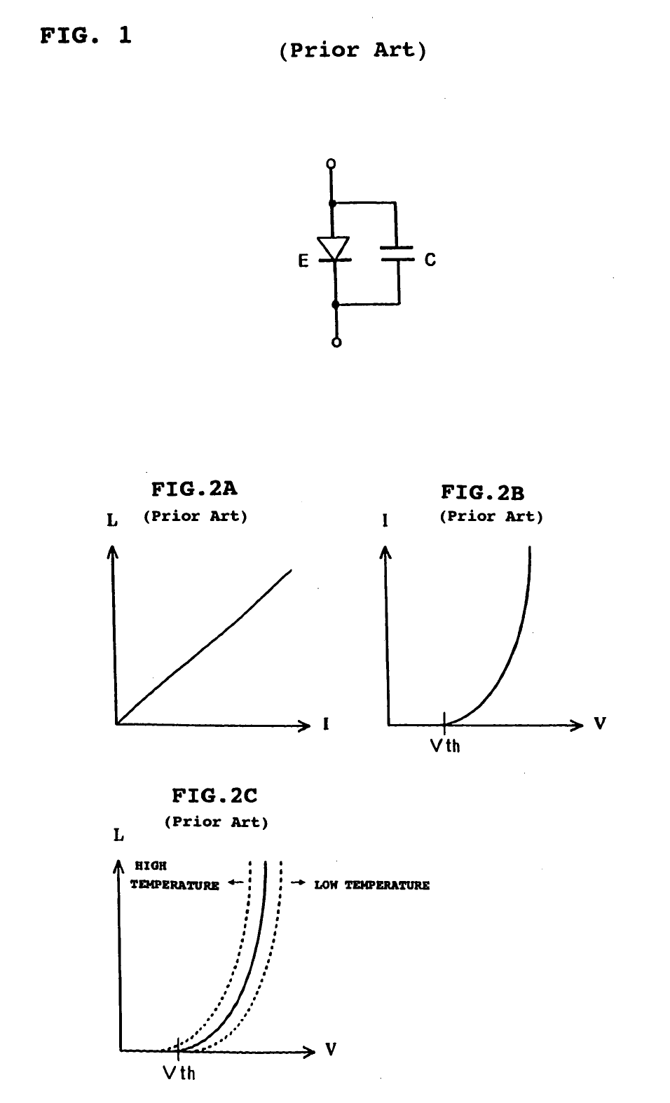

### DESCRIPTION OF THE PREFERRED EMBODIMENTS

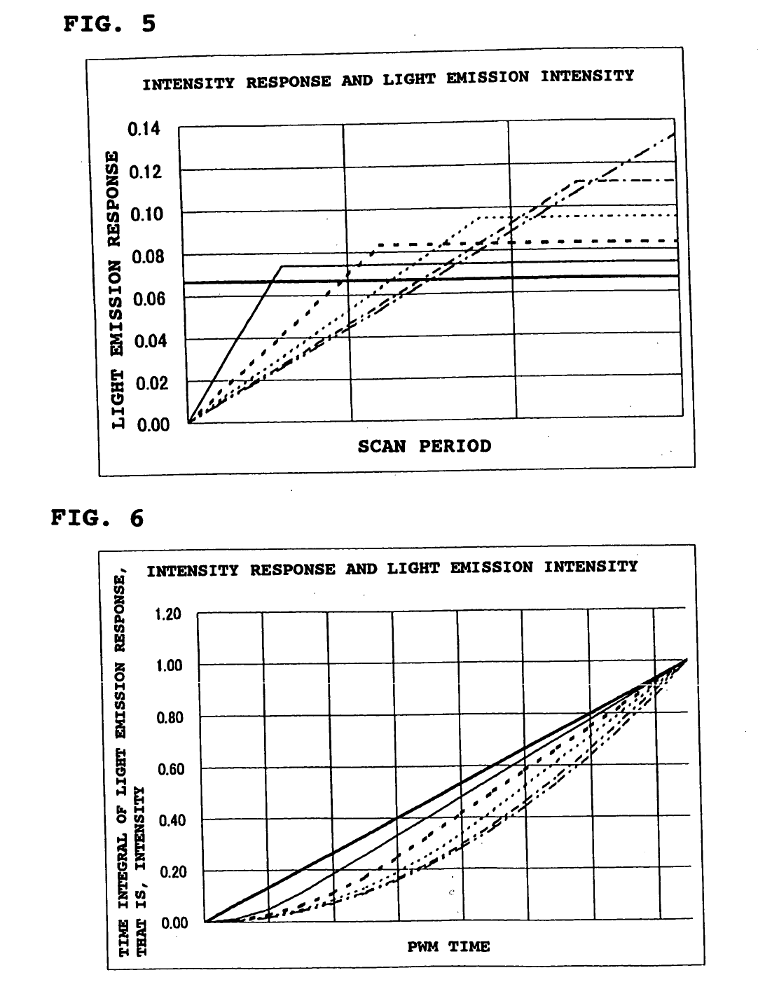

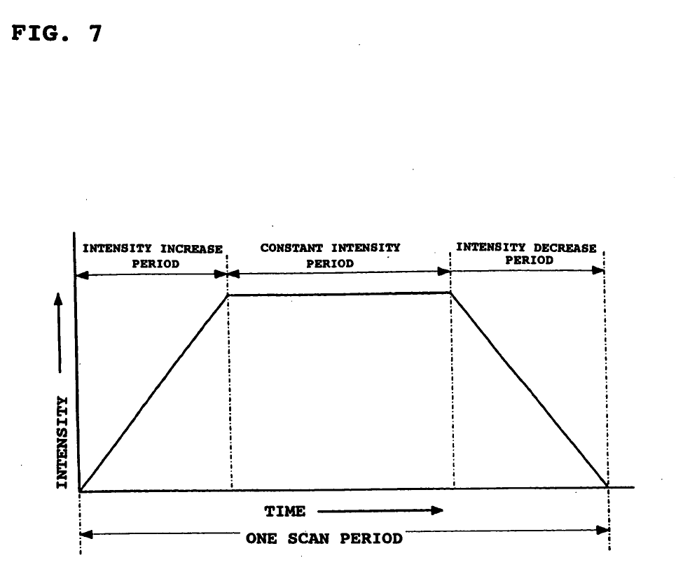

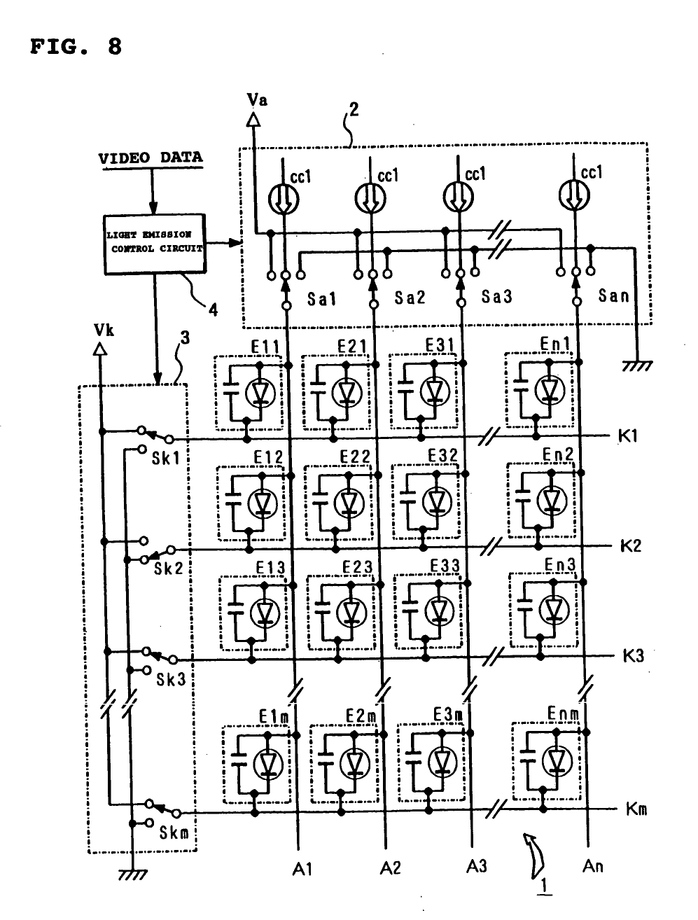

A drive device of a light emitting display panel in which the present invention is utilized will be described below based on preferred embodiments thereof. However, a basic concept of the present invention will be described before it with reference to FIGS. 5 to 7. First, FIG. 5 shows cases where intensity increase periods are 0 to 100% of a scan period and shows results of rough estimates for the relationships of gradations to intensities. The intensity can be found by time integral calculus for the light emission response, and results thereof are shown in FIG. 6. Respective solid line (bold line), solid line (thin line), broken line (bold line), broken line (thin line), alternate long and short dash line, and alternate long and two short dashes line shown in FIG. 5 correspond to respective those shown in FIG. 6.

As shown by, for example, the alternate long and short dash line and the alternate long and two short dashes line in FIG. 5, the longer the intensity increase period within the scan period, the more moderate intensity increase is shown in a low PWM region as shown in FIG. 6. That is, the light emission intensity of a light emitting element can have the characteristic as the gamma curve described based on FIG. 4. As a result, a minimum time resolution can be set largely, and it becomes unnecessary to increase the clock speed. Although the example shown in FIG. 5 shows the case where the intensity increases, in the case where the intensity decreases, a gradation characteristic approximating a reverse gamma curve can be expected, and in this case also a minimum time resolution can be set similarly largely, whereby it becomes unnecessary to increase the clock speed.

In sum, as shown in FIG. 7, within a predetermined period from a scan start in one scan period, by allowing the light emission intensity of a light emitting element to increase gradually so as to allow it to have an intensity increase period reaching to a constant intensity state, when this is integrated, this can be allowed to have a gradation characteristic as a gamma curve. Also, by allowing the light emission intensity of the light emitting element to have an intensity decrease period in which this is decreased gradually from the constant intensity state within a predetermined period immediately before the end of a scan period as shown in FIG. 7, when this is integrated, this can be allowed to have a gradation characteristic approximating a reverse gamma curve.

Thus, as shown in FIG. 7, a drive method of a light emitting display panel according to the present invention is characterized by adopting at least either one of setting an intensity increase period at a scan start time in one scan period or setting an intensity decrease period immediately before the end of a scan period. Thus, in the case where a time gradation is realized as described above, the minimum time resolution can be set largely, and it becomes unnecessary to increase the clock speed.

FIG. 8 shows a passive drive type display panel developed based on the above-described technical concept and a first embodiment of a drive device thereof. Operations thereof based on the embodiment shown in FIG. 8 will be described with reference to an example in which the intensity increase period is set at a scan start time in one scan period. There are two methods that are a cathode ray scan/anode ray drive and an anode ray scan/cathode ray drive in drive methods for organic EL elements in the passive drive type drive system, and the example shown in FIG. 8 shows the feature of the former cathode ray scan/anode ray drive.

That is, anode rays A1 to An as n data lines are arranged in a vertical direction, cathode rays K1 to Km as m scan lines are arranged in a horizontal direction, and organic EL elements E11 to Enm as light emitting elements are arranged at portions at which respective rays intersect each other (in total, nxm portions) to constitute a display panel 1.

One ends (anode terminals in equivalent diodes of the EL elements) and other ends (cathode terminals in the equivalent diodes of the EL elements) of the respective EL elements E11 to Enm constituting pixels are connected to the anode rays and cathode rays, respectively, corresponding to respective crossing positions between the anode rays A1 to An extending along the vertical direction and the cathode rays K1 to Km extending along the horizontal direction. Further, the respective anode rays A1 to An are connected to an anode ray drive circuit 2, and the respective cathode rays K1 to Km are connected to a cathode ray scan circuit 3, so as to be driven, respectively.

The anode ray drive circuit 2 is provided with respective constant current sources cc1 and drive switches Sa1 to San supplying drive current to the respective EL elements via the respective anode rays A1 to An. The drive switches Sa1 to San are connected to the respective constant current sources cc1 sides and are controlled so that current from the constant current sources cc1 is supplied to the respective EL elements E11 to Enm arranged corresponding to the cathode rays. The drive switches Sa1 to San are constructed so that the anode rays are selectively connected to a voltage source Va or a reference potential (a ground potential) as described later.

The cathode ray scan circuit 3 is provided with scan switches Sk1 to Skm corresponding to the respective cathode rays K1 to Km and operates so as to allow either one of a voltage source Vk or the ground potential as a scan reference potential to be connected to corresponding cathode rays. Thus, by connecting the constant current sources cc1 to desired anode rays A1 to An while the cathode rays are set at the scan reference potential (ground potential) at a predetermined cycle, light of the respective EL elements are selectively emitted.

The anode ray drive circuit 2 and the cathode ray scan circuit 3 receive commands from a light emission control circuit 4 and operate so as to display an image corresponding to image data, in response to said image data supplied to the light emission control circuit. In this case, the cathode ray scan circuit 3 sequentially selects one of the cathode rays corresponding to the horizontal scan period of the image data by a command from the light emission control circuit to set it to the ground potential as the scan reference potential and sequentially switches the scan switches Sk1 to Skm so that the voltage of the voltage source Vk is applied to other cathode rays. The state shown in FIG. 8 shows a state in which the second cathode ray K2 is scanned and in which the voltage of the voltage source Vk is applied to the other cathode rays.

A drive control signal for controlling any one of the EL elements connected to the cathode rays as to which timing and how long period of time light emission is performed based on pixel information that the image data shows is supplied from the light emission control circuit 4 to the anode ray drive circuit 2. The anode ray drive circuit 2 instantaneously connects some of the drive switches Sa1 to San to the voltage source Va and connects them to the constant current sources cc1 sides to control them in response to the drive control signal so as to supply drive current to EL elements corresponding to the pixel data via the anode rays A1 to An.

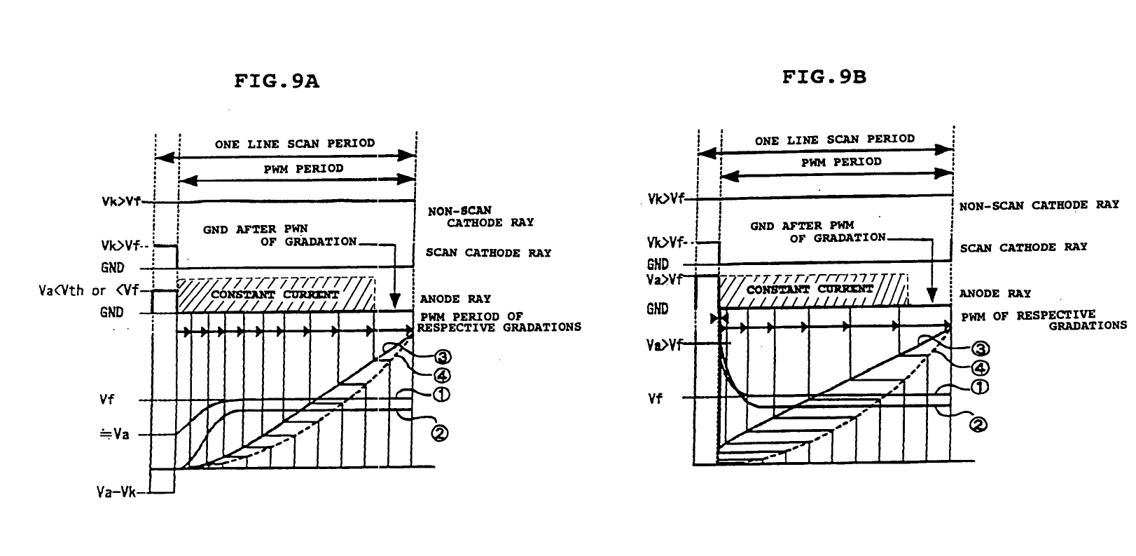

FIG. 9A is a timing diagram explaining lighting control for the display panel operated through the first embodiment shown in FIG. 8. In this FIG. 9A, the horizontal axis shows one line of scan period in one cathode ray. Reference numeral 1 in the drawing shows the applied voltage for the EL elements, and reference numeral 2 shows a light emission response characteristic of the EL element, that is, the light emission intensity. Further, reference numeral 3 shows the time integral value of the light emission response characteristic of the EL element shown as 2, and reference numeral 4 shows an ideal gamma curve.

In the embodiment shown in FIG. 8, as shown in FIG. 9A, the voltage value of the voltage source Va supplied to the anode ray drive circuit 2 is set to a voltage lower than a forward voltage Vf in the light emission state (the constant intensity period) of the EL element or the above-mentioned lighting threshold voltage Vth. The voltage value of the voltage source Vk utilized in the cathode ray scan circuit 3 is set to a voltage higher than the forward voltage Vf.

In the embodiment shown in FIG. 8, one means of the above-mentioned cathode reset method is adopted in the lighting control therefor. Here, one means of this cathode reset method is called a voltage setting means. As shown in FIG. 9A, at a beginning of one line scan period, the voltage of the voltage source Va is supplied to the anodes of the EL elements that are to be scan light emission objects via the anode rays. That is, the drive switches Sa1 to San in the anode ray drive circuit 2 are connected to the voltage source Va side.

The voltage from the voltage source Vk is supplied to the cathodes of the EL elements. That is, the scan switches Sk1 to Skm in the cathode ray scan circuit 3 are connected to the voltage source Vk side. Accordingly, in this state, the voltage of “Va-Vk” is applied to the EL elements as shown as 1 in FIG. 9A.

Thereafter, the drive switches Sa1 to San of the anode rays corresponding to EL elements whose lights are to be emitted are connected to the constant current sources cc1 side, and the cathode ray of the scan object is connected to the ground potential. As a result, electrical charges of non-scan line capacitances (usually, satisfactorily larger than capacitance components of a scan selected ray) connected to anode rays are concentrated (rush current) in the scan selected ray. As a result, the anode potentials become approximately the potential of Va by acceptance and delivery of electrical charges. That is, in a first set period of the scan period, setting is performed so that voltage between both ends of the EL element becomes approximately Va.

Thus, current from the constant current sources cc1 is supplied to EL elements that are to be the light emission objects, taking the anode side voltage Va as a starting point to enter a PWM period. In this PWM period since the EL element is driven by a constant current, the anode potential thereof shown by 1 is gradually raised and reaches the forward voltage Vf. Then, the EL element is driven by the constant current and shifts while still being the forward voltage Vf. As a result, an intensity increase period in which the light emission response of the EL element moderately increases as shown by 2 can be provided.

As already described, in the PWM gradation method, the relationship between the PWM time and the intensity is found by the time integral of the light emission response shown by 2 as shown by 3. Accordingly, PWM periods of respective gradations can be set by the time integral of the light emission response shown by 3. Therefore, by selecting the PWM periods of the respective gradations, in other words, by setting the drive switches Sa1 to San shown in FIG. 8 to the ground potential side in response to a gradation expression, the light emission time of an EL element can be controlled, and a gradation expression by the PWM gradation method can be realized.

The PWM periods of the respective gradations shown in FIG. 9A are set based on the light emission response characteristic shown by 2, and in the case where a further ideal gamma curve is sought, it is desired that the PWM time is adjusted on the time axis for each gradation by calculating back from an intensity value of the ideal gamma curve shown by 4. Thus, a gradation corresponding to the ideal gamma curve can be obtained.

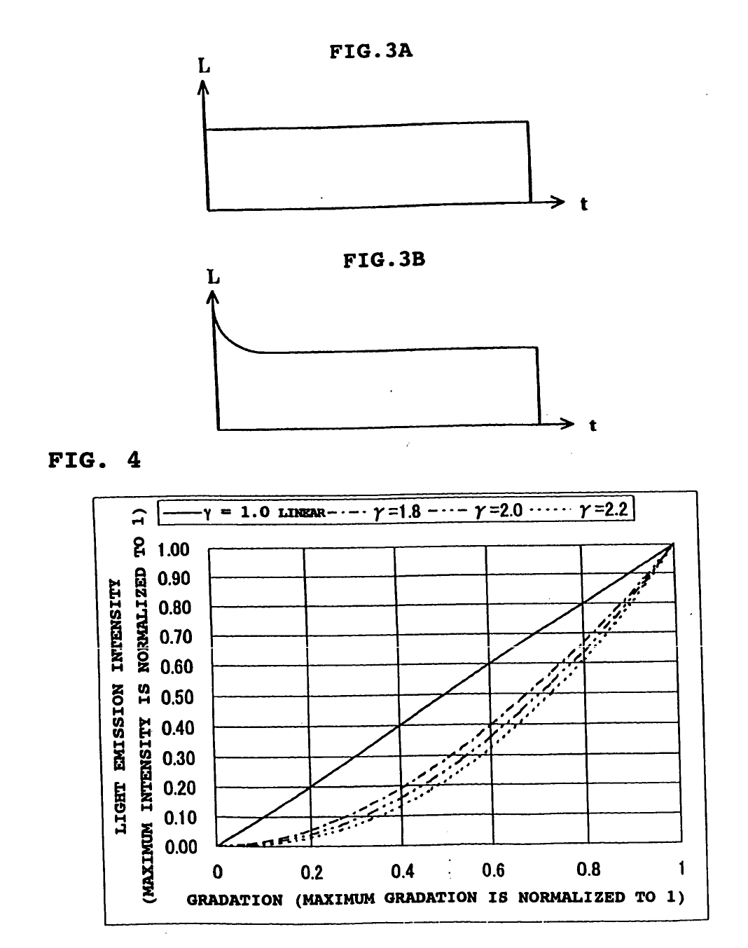

Meanwhile, FIG. 9B illustrates PWM periods of respective gradations performed in a conventional example having a light emission characteristic as shown in FIG. 3 which has already been described. Respective characteristics shown by 1 to 4 in FIG. 9B are similar to those described in FIG. 9A. That is, in the conventional method, the relationship between the anode side voltage Va and the forward voltage Vf is set to Va≧Vf, and therefore the rising of light emission of an EL element is rectangular or spike-like.

Therefore, in the case where PWM periods of respective gradations are set based on the light emission response shown by 2 in FIG. 9B where the rising of light emission is spick-like, an extremely small PWM resolution is needed in a low gradation side. Thus, in order to realize this resolution, the operation clock has to be increased considerably, which is a problem.

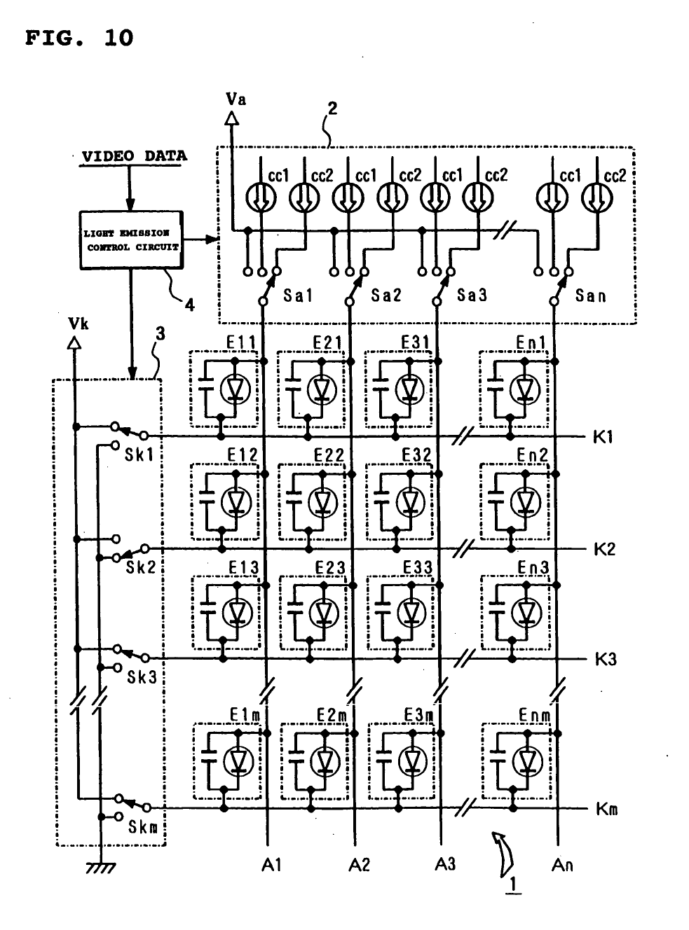

Next, FIG. 10 shows a second embodiment of a drive device according to the present invention. In FIG. 10, parts corresponding to the respective constituent parts shown in FIG. 8 which has already been described are shown by the same reference numerals, and thus detailed explanation thereof will be omitted. Operations thereof based on the embodiment shown in FIG. 10 will be described in accordance with an example in which an intensity increase period is set at a scan start time within one scan period.

In this embodiment shown in FIG. 10, respective first constant current sources cc1 for the light emission risings of EL elements and second constant current sources cc2 for performing the light emission in a constant intensity state are provided in the anode ray drive circuit 2. Further, the voltage value of the voltage source Va supplied to the anode ray drive circuit 2 is set at a voltage lower than the above-mentioned lighting threshold voltage Vth. The voltage value of the voltage source Vk utilized in the cathode ray scan circuit 3 is set at a voltage higher than the forward voltage Vf.

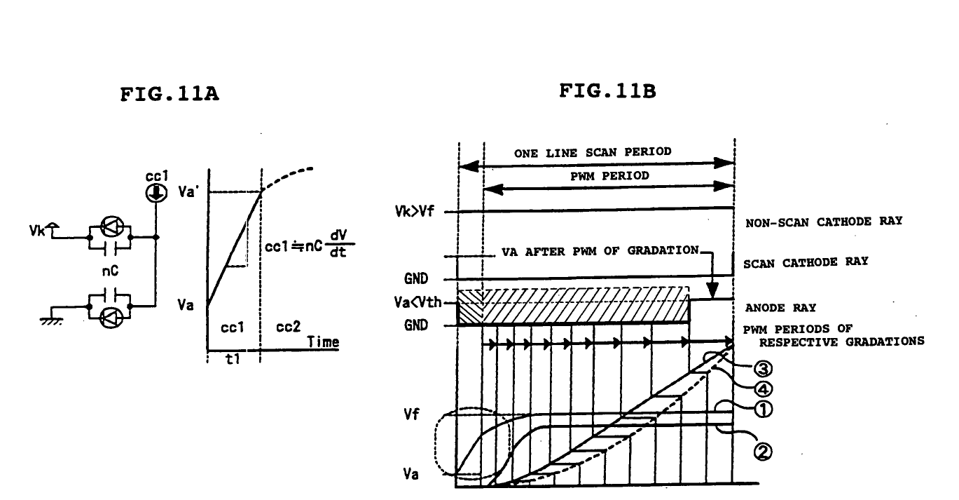

FIG. 11 is for explaining lighting control of the display panel performed by the second embodiment shown in FIG. 10. That is, FIG. 11A is for explaining the circumstances of the light emission rising of an EL element performed first in each one line scan period, and FIG. 1B is a timing diagram explaining the lighting control for the display panel. In FIG. 11B, similarly to the example shown in FIG. 9, the horizontal axis thereof shows one line of scan period in one cathode ray. The timing diagram shown in FIG. 11A explains a charging operation for an element at a beginning of one line scan period in FIG. 11B, that is, the part enclosed by broken lines.

In FIG. 11B, similarly to the example shown in FIG. 9, reference numeral 1 shows the applied voltage for the EL element, and 2 shows a light emission response characteristic of the EL element, that is, the light emission intensity. Further, 3 shows the time integral value of the light emission response characteristic of the EL element shown as the 2, and 4 shows an ideal gamma curve.

In this embodiment, for the time of scan of one line, the drive switches Sa1 to San have already been connected to the voltage source Va at a scan finishing time of a line before said line. A scan cathode ray is connected to the ground potential, and non-scan cathode rays are connected to the voltage source Vk. Thus, at a beginning of one line of scan, as shown in FIGS. 11A, 11B, the applied voltage to the respective EL elements that are to be scanned are allowed to be Va. That is, in the set period that is a beginning of the scan period, the voltage of both ends of the EL element is set to approximately Va, and here they function as a voltage setting means for setting the both end voltage of the EL element to a constant voltage value.

Then, the drive switches Sa1 to San are connected to the first constant current sources cc1 sides which are for light emission rising.

Here, FIG. 11A shows an equivalent circuit regarding one anode ray at this time, meaning a structure in which one EL element to be a scan object for the constant current source cc1 and a plurality of EL elements to be non-scan objects are connected in parallel and in which n parasitic capacitances C in total are connected. Charging operation is performed through the constant current source cc1 for the parasitic capacitances of the respective EL elements. At this time electrical charges corresponding to Va have already been charged in the parasitic capacitances C of the respective EL elements as described above. The applied voltage for the EL element rises from the Va, having the current characteristic of cc1=nc (dV/dt), and in the period of t1 in which the constant current source cc1 is connected, the applied voltage to the EL elements increases to Va′.

In this case, a middle level of current which can be roughly estimated from the capacitance value of the EL element is poured for a relatively long period of time. Current by which the anode voltage at the time of completion of t1 time becomes approximately Vf is desired. Thus, an intensity increase period in which the light emission response moderately increases as shown as 2 can be provided. The drive switches Sa1 to San are connected to the second constant current sources cc2 side after the completion of the t1 time, and thus the EL element emits light in the constant intensity state.

The reference numeral 3 in FIG. 11B is the time integral of the light emission response shown by 2, and thus the PWM periods of the respective gradations can be set. The drive switches Sa1 to San shown in FIG. 10 are set to the Va side in response to a gradation expression so that the light emission time of the EL element can be controlled, and a gradation expression by the PWM gradation method can be realized. As described based on FIG. 9, in the case where an ideal gamma curve is desired to be obtained, the PWM time can be adjusted on the time axis for each gradation by calculating back from an intensity value of the ideal gamma curve shown by 4, and thus a gradation corresponding to the ideal gamma curve can be obtained.

In the embodiment shown in FIG. 10, although the terminal voltages of EL elements are increased utilizing the constant current sources cc1 at a beginning of one scan period, a constant voltage source by which voltage gradually increases in the intensity increase period may be employed instead of the constant current source cc1. Even in the structure in which such constant voltage source is used, the intensity increase period can be formed at a beginning of one scan period, and similar interactions and effects can be obtained.

In this case, it is desired that the applied voltage to the light emitting element at the time of completion of the intensity increase period is set at a voltage value which is approximately equal to the forward voltage Vf of the light emitting element in the constant intensity state. By setting like this, the applied voltage of the EL element can be prevented being given a steep change, and therefore a small PWM resolution becomes unnecessary.

Although not particularly explained in the above-described embodiments, when a color display panel is employed as the display panel, it is desired to construct the first embodiment shown in FIG. 8 so that through at least one of the voltage source Va, the PWM time, and the current value of the constant current sources cc1, a drive operation which differs depending on respective colors can be performed.

In the case where a color display panel is adopted as the display panel, it is desired to construct the second embodiment shown in FIG. 10 so that through at least one of the voltage value of the voltage source Va, the respective current values of the constant current sources cc1 and cc2, time t1, and the PWM time, a drive operation which differs depending on respective colors can be performed.

Further, it is desired to construct a structure in which a constant voltage source by which voltage gradually increase is employed instead of the constant current source cc1 shown in FIG. 10 so that through at least one of voltage sweep widths (time length, current value, voltage value) and the like, a drive operation which differs depending on respective colors can be performed. By constructing so that a drive operation which differs depending on respective colors can be performed as described above, the intensity from a low gradation to a high gradation of an organic EL element which emits respective colors of light and white balance can be adjusted, whereby an excellent gamma characteristic can be obtained.

In any of the embodiments described above, although a drive method having the intensity increase period in which the light emission intensity of an EL element is gradually increased at a scan start time of a scan period is implemented, also by having an intensity decrease period in which the light emission intensity of an EL element is gradually decreased at a time before the completion of a scan period, an excellent gradation expression can be realized without subdividing intensity resolution so much as described above.

Such intensity decrease period can be realized by a setting in which the current value supplied to a light emitting element in a constant intensity state differs from the current value supplied to the light emitting element in the intensity decrease period. Further, a constant voltage source by which the voltage gradually decreases in the intensity decrease period may be employed.

In the case where the constant voltage source by which the voltage gradually decreases is employed as described above, it is desired that the applied voltage to the light emitting element at the start time of the intensity decrease period is set at a voltage value which is approximately equal to the forward voltage Vf of the light emitting element in the constant intensity state. By setting like this, a steep change can be prevented from being given to the applied voltage to the EL element, whereby a small PWM resolution becomes unnecessary.

What is claimed is:

1. A drive method for a light emitting display panel in which light emitting elements are connected at respective crossing points between a plurality of data lines and a plurality of scan lines so that the light emitting elements connected to the respective scan lines are sequentially selectively lighted by sequentially scanning the scan lines, wherein there is provided at least one of an intensity increase period in which a light emission intensity of the light emitting element is gradually increased allowing the light emission intensity to reach a constant intensity state within a predetermined period from a scan start in one scan period or an intensity decrease period in which the light emission intensity of the light emitting element is gradually decreased from the constant intensity state within a predetermined period which is immediately before the completion of the scan period.

2. The drive method for the light emitting display panel according to claim 1, wherein the value of current which is supplied to the light emitting element in the intensity increase period or the intensity decrease period and the value of current which is supplied to the light emitting element in the constant intensity state are set so that the both values of the currents are different from each other.

3. The drive method for the light emitting display panel according to claim 1, in the drive method for the light emitting display panel in which there is provided the intensity increase period in which a lighting intensity of the light emitting element is gradually increased allowing the lighting intensity to reach the constant intensity state within the predetermined period from the scan start in one scan period, wherein there is provided a set period in which the voltage of both ends of the light emitting element whose lighting is to be driven in a scan period is set at a predetermined voltage value at a beginning of said scan period corresponding to one scan line so that drive current for holding the constant intensity state is given to the light emitting element within the intensity increase period.

4. The drive method for the light emitting display panel according to claim 1, in the drive method for the light emitting display panel in which there is provided the intensity increase period in which a lighting intensity of the light emitting element is gradually increased allowing the lighting intensity to reach the constant intensity state within the predetermined period from the scan start in one scan period, wherein there is provided a set period in which the voltage of both ends of the light emitting element whose lighting is to be driven in a scan period is set at a predetermined voltage value immediately before a scan period corresponding to one scan line so that current which is different from drive current which is for holding the constant intensity state is given to the light emitting element within the intensity increase period.

5. The drive method for the light emitting display panel according to claim 3 or 4, wherein the value of voltage which is applied to both ends of the light emitting element in the set period is set at a voltage value which does not reach the forward voltage of the light emitting element in the constant intensity state.

6. The drive method for the light emitting display panel according to claim 1, wherein the light emitting element is driven by a voltage source whose output voltage changes gradually in the intensity increase period or the intensity decrease period.

7. The drive method for the light emitting display panel according to claim 6, wherein the applied voltage to the light emitting element at an end time of the intensity increase period or at a start time of the intensity decrease period is set at a voltage value which is approximately equal to the forward voltage of the light emitting element in the constant intensity state.

8. The drive method for the light emitting display panel according to any one of claims 1 to 4, wherein a light emitting element which emits different light emission colors is employed in the light emitting display panel.

9. The drive method for the light emitting display panel according to claim 5, wherein a light emitting element which emits different light emission colors is employed in the light emitting display panel.

10. The drive method for the light emitting display panel according to any one of claims 1 to 4, wherein a gradation expression is implemented through time gradation in which a light emission time of the light emitting element which includes at least either one of the intensity increase period or the intensity decrease period is controlled.

11. The drive method for the light emitting display panel according to claim 5, wherein a gradation expression is implemented through time gradation in which a light emission time of the light emitting element which includes at least either one of the intensity increase period or the intensity decrease period is controlled.

12. The drive method for the light emitting display panel according to claim 6 or 7, wherein a gradation expression is implemented through time gradation in which a light emission time of the light emitting element which includes at least either one of the intensity increase period or the intensity decrease period is controlled.

13. The drive method for the light emitting display panel according to claim 8, wherein a gradation expression is implemented through time gradation in which a light emission time of the light emitting element which includes at least either one of the intensity increase period or the intensity decrease period is controlled.

14. A drive device for a light emitting display panel of a passive drive system in which light emitting elements are connected at respective crossing points between a plurality of data lines and a plurality of scan lines so that the light emitting elements connected to the respective scan lines are sequentially selectively lighted by sequentially scanning the scan lines, wherein there is provided at least one of an intensity increase period in which a light emission intensity of the light emitting element is gradually increased allowing the light emission intensity to reach a constant intensity state within a predetermined period from a scan start in one scan period or an intensity decrease period in which the light emission intensity of the light emitting element is gradually decreased from the constant intensity state within a predetermined period which is immediately before the completion of the scan period.

15. The drive device for the light emitting display panel according to claim 14, wherein provided are a first constant current source which supplies a first value of current to the light emitting element during the intensity increase period or the intensity decrease period and a second constant current source which supplies a second value of current to the light emitting element in the constant intensity state, and that currents supplied from the first constant current source and the second constant current source are set at respectively different values.

16. The drive device for the light emitting display panel according to claim 14, in the drive device for the light emitting display panel in which there is provided the intensity increase period in which a lighting intensity of the light emitting element is gradually increased allowing the lighting intensity to reach the constant intensity state within the predetermined period from the scan start in one scan period, wherein there is provided a voltage setting means for setting the voltage of both ends of the light emitting element whose lighting is to be driven in a scan period at a predetermined voltage value at a beginning of said scan period corresponding to one scan line so that current from a constant current source which holds the constant intensity state is supplied to the light emitting element in a state in which a constant both end voltage is set in the light emitting element by the voltage setting means.

17. The drive device for the light emitting display panel according to claim 14, in the drive device for the light emitting display panel in which there is provided the intensity increase period in which a lighting intensity of the light emitting element is gradually increased allowing the lighting intensity to reach the constant intensity state within the predetermined period from the scan start in one scan period, wherein there is provided a voltage setting means for setting the voltage of both ends of the light emitting element whose lighting is to be driven in a scan period at a predetermined voltage value immediately before said scan period corresponding to one scan line so that current from a first constant current source which gradually increases the lighting intensity of the light emitting element is supplied in a state in which a constant both end voltage is set in the light emitting element by the voltage setting means and so that current from a second constant current source which holds the constant intensity state is supplied to the light emitting element in a state in which the lighting intensity of the light emitting element is increased up to a predetermined value.

18. The drive device for the light emitting display panel according to claim 16 or 17, wherein the both end voltage of the light emitting element which is set by the voltage setting means is set at a voltage value which does not reach the forward voltage of the light emitting element in the constant intensity state.

19. The drive device for the light emitting display panel according to claim 14, wherein the voltage from a voltage source whose output voltage gradually changes is applied to the light emitting element in the intensity increase period or in the intensity decrease period.

20. The drive method for the light emitting display panel according to claim 19, wherein the applied voltage from the voltage source to the light emitting element at an end time of the intensity increase period or at a start time of the intensity decrease period is set at a voltage value which is approximately equal to the forward voltage of the light emitting element in the constant intensity state.
